(19) United States
(12) Patent Application Publication
(10) Pub. No.: US 2014/0209478 A1
(43) Pub. Date: Jul. 31, 2014

(54) Artificial Photosynthetic System Using Photocatalyst

(71) Applicant: SUNPOWER TECHNOLOGIES LLC, (US)

(72) Inventor: Daniel Landry, Redondo Beach, CA (US)

(73) Assignee: SUNPOWER TECHNOLOGIES LLC, SAN MARCOS, CA (US)

(21) Appl. No.: 13/755,550

(22) Filed: Jan. 31, 2013

(51) Int. Cl. B01J 35/02; C25B 1/00

(52) U.S. Cl. CPC B01J 35/02; C25B 1/003
USPC 205/340; 502/1

(57) ABSTRACT

A photosynthetic system for splitting water to produce hydrogen and using the produced hydrogen for the reduction of carbon dioxide into methane is disclosed. The disclosed photosynthetic system employs photoactive materials that include photocatalytic capped colloidal nanocrystals within their composition, in order to harvest sunlight and obtain the energy necessary for water splitting and subsequent carbon dioxide reduction processes. The photosynthetic system may also include elements necessary to transfer water produced in the carbon dioxide reduction process, for subsequent use in water splitting process. The systems may also include elements necessary to store oxygen and collect and transfer methane, for subsequent transformation of methane into energy.

### BACKGROUND

1. Field of the Disclosure

The present disclosure relates generally to artificial photosynthetic systems, in particular to a system that combines photocatalytic materials for hydrogen and methane production.

2. Background Information

The conversion of sunlight and water into a clean, high efficiency chemical fuel has been a goal for a number of years and the urgency increases as damaging effects of burning fossil fuels becomes ever more apparent. Fossil fuels are used in just about every sector of the modern industry and society, about 45% of the United States energy was produced by petroleum and coal in 2010, during this same year only 8% was recorded to be produced by renewable energy supplies. It is well known that it takes hundreds of millions of years for fossil fuels to be formed, and even more important, scientific studies have forecasted the end of fossil fuels by 2100.

The conventional methods form described the formation of photocatalytic nanoparticles in various classical polymers, such as organization and immobilization of metal compounds in linear, branched and cross-linked polymers.

In general, current photocatalytic systems suffer from low reaction rates. Reaction-induced changes in pH, donor concentrations, and surface trap sites may be at least partly responsible for low reaction rates observed.

### SUMMARY

There is a desire for an optimization of complete photosynthetic systems that may be used to convert sunlight, water, and CO₂ into methane fuel using nanocrystalline solids with the ability to optimize the efficiency of a photosynthetic system in order to make it commercially viable.

The embodiments described herein refer to an artificial photosynthetic system employing sunlight, which includes a first photoactive material to split water into hydrogen and oxygen, for subsequent use of hydrogen in the same artificial photosynthetic system with a second photoactive material for carbon dioxide reduction into water and methane.

Photoactive materials described herein may include photocatalytic capped colloidal nanocrystals structured with semiconductor nanocrystals, exhibiting the ability to absorb light for producing charge carriers to accelerate necessary redox reactions and prevent charge carriers recombination.

The artificial photosynthetic system includes the splitting of water into hydrogen and oxygen, for which a continuous flow of water may enter a first reaction vessel and may subsequently pass through a region containing the first photoactive material. When light with energy greater than that of the band gap of semiconductor nanocrystals, within first photoactive material, makes contact with semiconductor nanocrystals, electrons are excited from the valence band to the conduction band, leaving holes behind in the valence band. This process is called charge separation. Consequently, hydrogen molecules in water may be reduced when receiving two photo-excited electrons, and oxygen molecules in water may be oxidized when receiving four holes. The energy gap of absorber semiconductor nanocrystals should be large enough to drive the water splitting reaction, but small enough to absorb a large fraction of light wavelengths incident upon the surface of the earth. Semiconductor nanocrystals in first photoactive material may absorb light at different tunable wavelengths as a function of the particle size and generally at shorter wavelengths from the bulk material. For these redox reactions to occur, the minimum of energy from sunlight may be close to 2.1 eV.

After a first reaction vessel, hydrogen and oxygen may migrate through an opening into a gas collecting chamber, which may include a suitable permeable membrane to transfer hydrogen to a second reaction vessel. The gas collecting chamber may include a suitable permeable membrane to transfer oxygen and collect it in a storage tank.

Similarly, carbon dioxide may be injected to the second reaction vessel. According to embodiments described herein, a photocatalytic system may employ CO₂, produced as a byproduct during manufacturing processes, such as carbon dioxide coming from a boiler or other combustion equipment. Hydrogen, transferred from gas collecting chamber, and carbon dioxide may pass through a second photoactive material prior to entering the second reaction vessel.

When light with energy higher than that of the band gap of semiconductor nanocrystals within second photoactive material makes contact with second photoactive material, the process of charge separation may take place. Consequently, electrons from the photoactive material may reduce carbon dioxide into water and methane through a series of reactions.

The band gap of photocatalytic capped colloidal nanocrystals within second photoactive material employed in the reduction of CO₂ is at least 1.33 eV, which corresponds to absorption of solar photons of wavelengths below 930 nm. Considering the energy loss associated with entropy change (87 J/mol·K) and other losses involved in CO₂ reduction, a band gap between about 2 and about 2.4 eV may be preferred.

The structure of the inorganic capping agents within both photoactive materials may speed up redox reactions by quickly transferring charge carriers sent by semiconductor nanocrystals to water in order that the consequent water splitting and CO₂ reduction may take place at a faster and more efficient rate and at the same time inhibiting electron-hole recombination.

Any light source may be employed to provide light for both water splitting and CO₂ reduction. A preferable light source is sunlight, containing infrared light that may be used to heat water and also containing ultraviolet light and visible light.

Artificial photosynthetic systems, according to embodiments, may be mounted on a structure such as the roof of a building or may be free standing, such as in a field.

In one embodiment, a photosynthetic system comprises a photoactive material comprising photocatalytic capped colloidal nanocrystals, wherein methane and water are produced by a carbon dioxide reduction process in the presence of hydrogen.

In another embodiment, a photosynthetic method comprisies passing water from a first reaction vessel through a region having a first photoactive material, wherein the first photoactive material has semiconductor nanocrystals; exposing the first photoactive material to emitted light having energy greater than that of the band gap of semiconductor nanocrystals within the first photoactive material; migrating hydrogen and oxygen through an opening into a gas collecting chamber comprising a permeable membrane that transfers hydrogen to a second reaction vessel; passing the hydrogen and carbon dioxide through a second photoactive material having semicondutor nanycrystals prior to entering a second reaction vessel; injecting carbon dioxide into the second reaction vessel; and exposing the second photoactive material to emitted light with energy higher than that of the band gap of semiconductor nanocrystals with the second photoactive material.

In yet another embodiment, a photosynthetic system comprises a first photoactive material comprising photocatalytic capped colloidal nanocrystals; and a second photoactive material comprising photocatalytic capped colloidal nanocrystals, wherein methane and water are produced by a carbon dioxide reduction process in the presence of hydrogen.

Additional features and advantages of an embodiment will be set forth in the description which follows, and in part will be apparent from the description. The objectives and other advantages of the invention will be realized and attained by the structure particularly pointed out in the exemplary embodiments in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

Embodiments of the present invention are described by way of example with reference to the accompanying figures, which are schematic and are not intended to be drawn to scale. Unless indicated as representing the prior art, the figures represent aspects of the invention.

FIG. 1 is a block diagram of a method for forming a composition of photocatalytic capped colloidal nanocrystals, according to an embodiment.

FIG. 2 depicts an illustration of a tetrapod configuration of photocatalytic capped colloidal nanocrystals, according to an embodiment.

FIG. 3 illustrates a photoactive material A employed for the water splitting process, according to an embodiment.

FIG. 4 illustrates a photoactive material B employed for the carbon dioxide reduction process, according to an embodiment.

FIG. 5 depicts charge separation process that may occur during water splitting process, according to an embodiment.

FIG. 6 illustrates charge separation process that may occur during carbon dioxide reduction process, according to an embodiment.

FIG. 7 shows water splitting process taking place in a reaction vessel A, according to an embodiment.

FIG. 8 represents carbon dioxide reduction process taking place in a reaction vessel B, according to an embodiment.

FIG. 9 shows a photosynthetic system, according to an embodiment.

### DETAILED DESCRIPTION

Reference will now be made in detail to the preferred embodiments, examples of which are illustrated in the accompanying drawings. The embodiments described above are intended to be exemplary. One skilled in the art recognizes that numerous alternative components and embodiments that may be substituted for the particular examples described herein and still fall within the scope of the invention.

The present disclosure is described in detail with reference to embodiments illustrated in the drawings, which form a part hereof. In the drawings, which are not necessarily to scale or to proportion, similar symbols typically identify similar components, unless context dictates otherwise. Other embodiments may be used and/or other changes may be made without departing from the spirit or scope of the present disclosure. The illustrative embodiments described in the detailed description are not meant to be limiting of the subject matter presented.

### Definitions

As used herein, the following terms have the following definitions:

“Electron-hole pairs” refers to charge carriers that are created when an electron acquires energy sufficient to move from a valence band to a conduction band and creates a free hole in the valence band, thus starting a process of charge separation.

“Inorganic capping agent” refers to semiconductor particles that cap semiconductor nanocrystals and act as photocatalysts that quickly transfer electron-hole pairs and begin a reduction-oxidation reaction of carbon dioxide and hydrogen.

“Photoactive material” refers to at least one substance that may be used in photocatalytic processes for absorbing light and starting a chemical reaction with light.

“Semiconductor nanocrystals” refers to particles sized between about 1 and about 100 nanometers made of semiconducting materials with large surface areas able to absorb light and initiate an electron-hole pair production that triggers the photochemical reaction of carbon dioxide reduction.

Method for forming composition of photocatalytic capped colloidal nanocrystals:

Disclosed herein is a photosynthetic system employing photocatalytic capped colloidal nanocrystals that may be included in a photoactive material where methane and water are produced by a carbon dioxide reduction process in the presence of hydrogen obtained from a water splitting process, according to an embodiment.

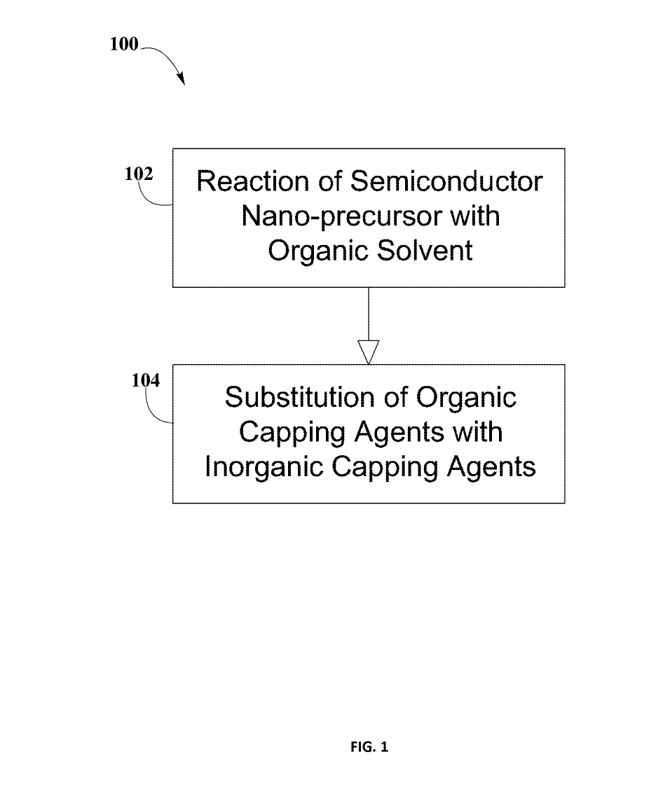

FIG. 1 is a flow diagram of a method 100 for forming a composition of photocatalytic capped colloidal nanocrystals. Photocatalytic capped colloidal nanocrystals may be synthesized following conventional protocols known to one of ordinary skill in the art. Photocatalytic capped colloidal nanocrystals may include one or more semiconductor nanocrystals and one or more inorganic capping agents.

To synthesize the photocatalytic capped colloidal nanocrystals, semiconductor nanocrystals are first grown by reacting semiconductor nanocrystal precursors in the presence of an organic solvent 102. Here, the organic solvent may be a stabilizing organic ligand, referred in this description as an organic capping agent. One example of an organic capping agent may be trioctylphosphine oxide (TOPO). This compound may be used in the manufacture of CdSe, among other semiconductor nanocrystals. TOPO 99% may be obtained from Sigma-Aldrich (St. Louis, Mo.). TOPO capping agent prevents the agglomeration of semiconductor nanocrystals during and after their synthesis. Additionally, the long organic chains radiating from organic capping agents on the surface of semiconductor nanocrystals may assist in suspending or dissolving those nanocrystals in a solvent. Other suitable organic capping agents may include long-chain aliphatic amines, long-chain aliphatic phosphines, long-chain aliphatic carboxylic acids, long-chain aliphatic phosphonic acids and mixtures thereof.

Examples of semiconductor nanocrystals may include the following: AlN, AlP, AlAs, Ag, Au, Bi, Bi₂S₃, Bi₂Se₃, Bi₂Te₃, CdS, CdSe, CdTe, Co, CoPt, CoPt₃, Cu, Cu₂S, Cu₂Se, CuInSe₂, CuIn₍₁₋ₓ₎Gaₓ(S,Se)₂, Cu₂ZnSn(S,Se)₄, Fe, FeO, Fe₂O₃, Fe₃O₄, FePt, GaN, GaP, GaAs, GaSb, GaSe, Ge, HgS, HgSe, HgTe, InN, InP, InSb, InAs, Ni, PbS, PbSe, PbTe, Pd, Pt, Ru, Rh, Si, Sn, ZnS, ZnSe, ZnTe, and mixtures of those compounds. Additionally, examples of applicable semiconductor nanocrystals may further include core/shell semiconductor nanocrystals such as Au/PbS, Au/PbSe, Au/PbTe, Ag/PbS, Ag/PbSe, Ag/PbTe, Pt/PbS, Pt/PbSe, Pt/PbTe, Au/CdS, Au/CdSe, Au/CdTe, Ag/CdS, Ag/CdSe, Ag/CdTe, Pt/CdS, Pt/CdSe, Pt/CdTe, Au/FeO, Au/Fe₂O₃, Au/Fe₃O4, Pt/FeO, Pt/Fe₂O₃, Pt/Fe₃O₄, FePt/PbS, FePt/PbSe, FePt/PbTe, FePt/CdS, FePt/CdSe, FePt/CdTe, CdSe/CdS, CdSe/ZnS, InP/CdSe, InP/ZnS, InP/ZnSe, InAs/CdSe, and InAs/ZnSe; nanorods such as CdSe; core/shell nanorods such as CdSe/CdS; nano-tetrapods such as CdTe, and core/shell nano-tetrapods such as CdSe/CdS.

Varying the size of semiconductor nanocrystals may often be achieved by changing the reaction time, reaction temperature profile, or structure of organic capping agent used to passivate the surface of semiconductor nanocrystals during growth. The chemistry of capping agents may control several of the system parameters, such as the growth rate, the shape, the dispersibility of semiconductor nanocrystals in various solvents and solids, and even the excited state lifetimes of charge carriers in semiconductor nanocrystals. The flexibility of the chemical synthesis is demonstrated by the fact that often one capping agent may be chosen for its growth control properties and may be later substituted out after synthesis for a different capping agent in order to provide an interface more suitable to the application or to modify the optical properties and charge carriers mobility of semiconductor nanocrystals. In addition to the previous colloidal route, other synthetic routes for growing semiconductor nanocrystals have been reported in the prior art, such as high-temperature and high-pressure autoclave based methods, as well as traditional routes using high temperature solid state reactions and template-assisted synthetic methods.

Examples of the morphologies of semiconductor nanocrystals may include nanocrystals, nanorods, nanoplates, nanowires, dumbbell-like nanoparticles, carbon nanotubes, nanosprings, and dendritic nanomaterials. Within each morphology, there may be additional large variety of shapes available, for example, semiconductor nanocrystals may be produced in spheres, cubes, tetrahedra (tetrapods), octahedra, icosahedra, prisms, cylinders, wires, branched, and hyper branched morphologies and the like. The morphology and the size of semiconductor nanocrystals do not inhibit the general method 100 for forming composition for making photocatalytic capped colloidal nanocrystals described herein; specifically the selection of morphology and size of semiconductor nanocrystals may allow for the tuning and control of the properties of photocatalytic capped colloidal nanocrystals.

In order to modify optical properties as well as to enhance charge carriers mobility, semiconductor nanocrystals may be capped by inorganic capping agents in polar solvents instead of organic capping agents. Throughout the detailed description of the present disclosure, inorganic capping agents may be employed as photocatalysts to facilitate a photocatalytic reaction on semiconductor nanocrystals surface. Optionally, semiconductor nanocrystals may be modified by the addition of not one but two different inorganic capping agents, a reduction inorganic capping agent, to facilitate the reduction half-cell reaction, and an oxidation inorganic capping agent, to facilitate the oxidation half-cell reaction.

Inorganic capping agents may be neutral or ionic, may be discrete species, linear or branched chains, or two-dimensional sheets. Ionic inorganic capping agents are commonly referred to as salts, a pairing of a cation and an anion, and the portion of the salt specifically referred to as an inorganic capping agent is the ion that displaces organic capping agent and may cap semiconductor nanocrystals.

Additionally, method 100 involves substitution of organic capping agents with inorganic capping agents 104. There, organic capped semiconductor nanocrystals in the form of a powder, suspension, or a colloidal solution, may be mixed with inorganic capping agents, causing a reaction of organic capped semiconductor nanocrystals with inorganic capping agents. This reaction rapidly produces insoluble and intractable materials. Then, a mixture of immiscible solvents may be used to control the reaction, facilitating a rapid and complete exchange of organic capping agents with inorganic capping agents. During this exchange, organic capping agents are released.

Generally, inorganic capping agents may be dissolved in a polar solvent, a first solvent, while organic capped semiconductor nanocrystals may be dissolved in an immiscible, generally non-polar, solvent, a second solvent. These two solutions, including the mixture of immiscible solvents, may be then combined in a single vessel and stirred for about 10 minutes, after which a complete transfer of semiconductor nanocrystals from non-polar solvent to polar solvent may be observed. Immiscible solvents may facilitate a rapid and complete exchange of organic capping agents with inorganic capping agents.

Organic capped semiconductor nanocrystals may react with inorganic capping agents at or near the solvent boundary, the region where the two solvents meet, and a portion of organic capping agents may be exchanged/replaced with inorganic capping agents. That is, inorganic capping agents may displace organic capping agents from a surface of semiconductor nanocrystals and inorganic capping agents may bind to the surface of semiconductor nanocrystals. The process continues until an equilibrium may be established between inorganic capping agents on semiconductor nanocrystals and free inorganic capping agents. Preferably, the equilibrium favors inorganic capping agents on semiconductor nanocrystals. All the above described steps may be carried out under a nitrogen environment inside a glove box.

Examples of polar solvents may include 1,3-butanediol, acetonitrile, ammonia, benzonitrile, butanol, dimethylacetamide, dimethylamine, dimethylsulfoxide (DMSO), dioxane, ethanol, ethanolamine, ethylenediamine, ethyleneglycol, formamide (FA), glycerol, methanol, methoxyethanol, methylamine, methylformamide, methylpyrrolidinone, pyridine, water, and mixtures thereof.

Examples of non-polar or organic solvents may include pentanes, hexanes, heptane, octane, isooctane, nonane, decane, dodecane, hexadecane, benzene, toluene, petroleum ether, ethyl acetate, diisopropyl ether, diethyl ether, carbon tetrachloride, carbon disulfide, and mixtures thereof; provided that organic solvent is immiscible with polar solvent. Other immiscible solvent systems that are applicable may include aqueous-fluorous, organic-fluorous, and those using ionic liquids.

The purification of chemicals may require some isolation procedure and for inorganic capped semiconductor nanocrystals this procedure is often the precipitation of inorganic product allowing to wash inorganic product of impurities and/or unreacted materials. The isolation of the precipitated inorganic products then may allow for the selective application of inorganic capped semiconductor nanocrystals herein referred to as photocatalytic capped colloidal nanocrystals.

Preferred inorganic capping agents for photocatalytic capped colloidal nanocrystals may include polyoxometalates and oxometalates, such as tungsten oxide, iron oxide, gallium zinc nitride oxide, bismuth vanadium oxide, zinc oxide, reduced graphene oxide, titanium dioxide, among others.

Inorganic capping agents may include metals selected from transition metals, lanthanides, actinides, main group metals, metalloids, and mixtures thereof. Inorganic capping agents further may include soluble metal chalcogenides and/or metal carbonyl chalcogenides.

Method 100 for forming composition may be adapted to produce a wide variety of photocatalytic capped colloidal nanocrystals. Adaptations of method 100 for forming composition may include adding two different inorganic capping agents to a single semiconductor nanocrystals (e.g., Au.(Sn₂S₆; In₂Se₄); Cu₂Se.(In₂Se₄; Ga₂Se₃)), adding two different semiconductor nanocrystals to a single inorganic capping agent (e.g., (Au; CdSe).Sn₂S₆; (Cu₂Se; ZnS).Sn₂S₆), adding two different semiconductor nanocrystals to two different inorganic capping agents (e.g., (Au; CdSe).(Sn₂S₆; In₂Se₄)), and/or additional multiplicities.

The sequential addition of inorganic capping agents to semiconductor nanocrystal may be possible under the disclosed method. Depending, for example, upon concentration, nucleophilicity, capping agent to semiconductor nanocrystal bond strength, and semiconductor nanocrystal face dependent capping agent to semiconductor nanocrystal bond strength, inorganic capping of semiconductor nanocrystals may be manipulated to yield other combinations.

As used herein, the denotation Au.Sn₂S₆ may refer to an Au semiconductor nanocrystal capped with a Sn₂S₆ inorganic capping agent. Charges on inorganic capping agent are omitted for clarity. This nomenclature [semiconductor nanocrystal].[inorganic capping agent] is used throughout this description. The specific percentages of semiconductor nanocrystals and inorganic capping agents may vary between different types of photocatalytic capped colloidal nanocrystal.

Examples of photocatalytic capped colloidal nanocrystals may include rGO.TiO₂, Au.AsS₃, Au.Sn₂S₆, Au.SnS₄, Au.Sn₂Se₆, Au.In₂Se₄, Bi₂S₃.Sb₂Te₅, Bi₂S₃.Sb₂Te₇, Bi₂Se₃.Sb₂Te₅, Bi₂Se₃.Sb₂Te₇, CdSe.Sn₂S₆, CdSe.Sn₂Te₆, CdSe.In₂Se₄, CdSe.Ge₂S₆, CdSe.Ge₂Se₃, CdSe.HgSe₂, CdSe.ZnTe, CdSe.Sb₂S₃, CdSe.SbSe₄, CdSe.Sb₂Te₇, CdSe.In₂Te₃, CdTe.Sn₂S₆, CdTe.Sn₂Te₆, CdTe.In₂Se₄, Au/PbS.Sn₂S₆, Au/PbSe.Sn₂S₆, Au/PbTe.Sn₂S₆, Au/CdS.Sn₂S₆, Au/CdSe.Sn₂S₆, Au/CdTe.Sn₂S₆, FePt/PbS.Sn₂S₆, FePt/PbSe.Sn₂S₆, FePt/PbTe.Sn₂S₆, FePt/CdS.Sn₂S₆, FePt/CdSe.Sn₂S₆, FePt/CdTe.Sn₂S₆, Au/PbS.SnS₄, Au/PbSe.SnS₄, Au/PbTe.SnS₄, Au/CdS.SnS₄, Au/CdSe.SnS₄, Au/CdTe.SnS₄, FePt/PbS.SnS₄ FePt/PbSe.SnS₄, Fe Pt/PbTe.SnS₄, FePt/CdS.SnS₄, FePt/CdSe.SnS₄, FePt/CdTe.SnS₄, Au/PbS.In₂Se₄Au/PbSe.In₂Se₄, Au/PbTe.In₂Se₄, Au/CdS.In₂Se₄, Au/CdSe.In₂Se₄, Au/CdTe.In₂Se₄, FePt/PbS.In₂Se₄FePt/PbSe.In₂Se₄, FePt/PbTe.In₂Se₄, FePt/CdS.In₂Se₄, FePt/CdSe.In₂Se₄, FePt/CdTe.In₂Se₄, CdSe/CdS.Sn₂S₆, CdSe/CdS.SnS₄, CdSe/ZnS.SnS₄, CdSe/CdS.Ge₂S₆, CdSe/CdS.In₂Se₄, CdSe/ZnS.In₂Se₄, Cu.In₂Se₄, Cu₂Se.Sn₂S₆, Pd.AsS₃, PbS.SnS₄, PbS.Sn₂S₆, PbS.Sn₂Se₆, PbS.In₂Se₄, PbS.Sn₂Te₆, PbS.AsS₃, ZnSe.Sn₂S₆, ZnSe.SnS₄, ZnS.Sn₂S₆, and ZnS.SnS₄. As well as ZnS.TiO₂, TiO₂.CuO, ZnS.RuOₓ, ZnS.ReOₓ, among others.

Structure of Photocatalytic Capped Colloidal Nanocrystal

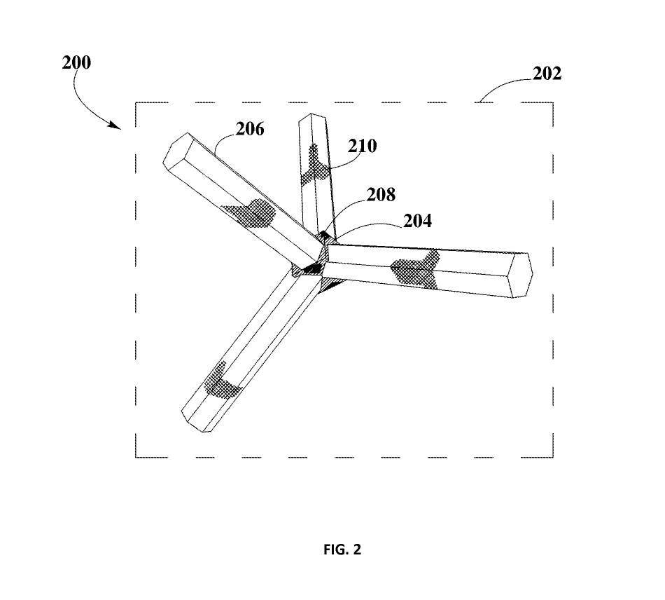

FIG. 2 depicts an illustrative embodiment of a tetrapod configuration 200 of a photocatalytic capped colloidal nanocrystal 202, that may include a first semiconductor nanocrystal 204 and a second semiconductor nanocrystal 206 that may be capped respectively with a first inorganic capping agent 208 and a second inorganic capping agent 210. As an example, the photocatalytic capped colloidal nanocrystals 202 in the tetrapod configuration 200 may include (CdSe; CdS).(Sn₂S₆⁴⁻; In₂Se₄²⁻), in which the first semiconductor nanocrystal 204 may be (CdSe), coated with Sn₂S₆⁴⁻ as the first inorganic capping agent 208, while the second semiconductor nanocrystal 206 may be (CdS), capped with In₂Se₄²⁻ as the second inorganic capping agent 210.

In addition, the shape of semiconductor nanocrystals may improve photocatalytic activity of semiconductor nanocrystals. Changes in shape may expose different facets as reaction sites and may change the number and geometry of step edges where reactions may preferentially take place.

Formation of Photoactive Material

In order to form photoactive material A and photoactive material B, photocatalytic capped colloidal nanocrystals 202 may be applied to suitable substrate by different means including plating, chemical synthesis in solution, chemical vapor deposition (CVD), plasma enhanced chemical vapor deposition (PECVD), laser ablation, thermal evaporation, molecular beam epitaxy, electron beam evaporation, pulsed laser deposition (PLD), sputtering, reactive sputtering, atomic layer deposition, sputter deposition, electrostatic deposition, spin coating, inkjet deposition, laser printing (matrices), spraying deposition and annealing methods and any combinations thereof. Thickness of photocatalytic capped colloidal nanocrystals 202 can be varied to tune properties of resultant photoactive material.

In an embodiment, spraying deposition and annealing methods may be used to apply and thermally treat photocatalytic capped colloidal nanocrystals 202 composition on a suitable substrate.

Yet another aspect of the present disclosure is thermal treatment of the herein described photocatalytic capped colloidal nanocrystals 202. Many of first inorganic capping agents 208 or second inorganic capping agents 210 may be precursors to inorganic materials (matrices) and low-temperature thermal treatment of first inorganic capping agents 208 or second inorganic capping agents 210 employing a convection heater may provide a gentle method to produce crystalline films from photocatalytic capped colloidal nanocrystals 202. The thermal treatment of photocatalytic capped colloidal nanocrystals may yield, for example, ordered arrays of semiconductor nanocrystals within an inorganic matrix, hetero-alloys, or alloys. In at least one embodiment herein, the convection heat applied over photocatalytic capped colloidal nanocrystals 202 may reach temperatures less than about 350, 300, 250, 200, and/or 180° C.

As a result of spraying deposition and annealing methods, a photoactive material A may be formed. The photoactive material A may then be cut into films to be used in subsequent water splitting process.

Suitable materials for substrate for photoactive material A, employed in water splitting process, may be polydiallyldimethylammonium chloride (PDDA), among others.

In one embodiment, the above described deposition method may be employed for forming photoactive material B that may be employed in carbon dioxide reduction process. In order to form photoactive material B, photocatalytic capped colloidal nanocrystals 202 may be deposited on a porous substrate. Porous substrate may have a pore size sufficient for gas (i.e. CO₂ and H₂) to pass through at a constant flow rate. In some embodiments, the porous substrate may also be optically transparent in order to allow photocatalytic capped colloidal nanocrystals 202 to receive more light. Suitable material for porous substrate may include glass frits, fiberglass cloth, porous alumina and porous silicon, among others.

As a result of spraying deposition and annealing methods, photoactive material B may be formed. Photoactive material B may then be cut into films to be used in subsequent carbon dioxide reduction process.

According to another embodiment, deposition on porous substrate may not be needed for any of the processes. Accordingly, photocatalytic capped colloidal nanocrystals 202 may be deposited into a crucible to be then annealed. Solid photocatalytic capped colloidal nanocrystals 202 may then be ground into particles and sintered together to form photoactive materials A and photoactive material B that may be deposited on surfaces, where the photoactive materials may adhere. In another embodiment, ground particles may be used directly as photoactive materials A and photoactive material B.

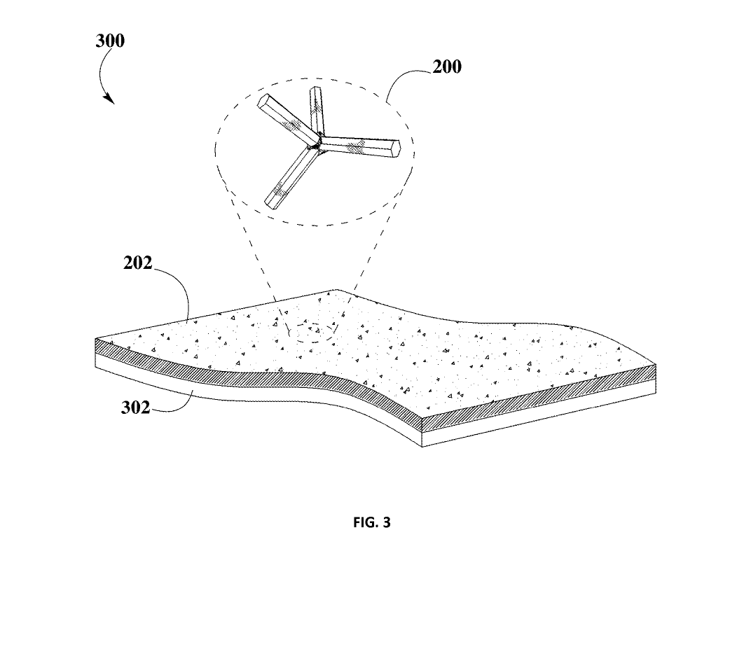

FIG. 3 illustrates a photoactive material A 300 including treated photocatalytic capped colloidal nanocrystals 202 in a tetrapod configuration 200 over a substrate 302. Photocatalytic capped colloidal nanocrystals 202 in the photoactive material A 300 may also exhibit tetrapod, core/shell, nanorods, nanowires, nanosprings and carbon nanotubes configuration, among others.

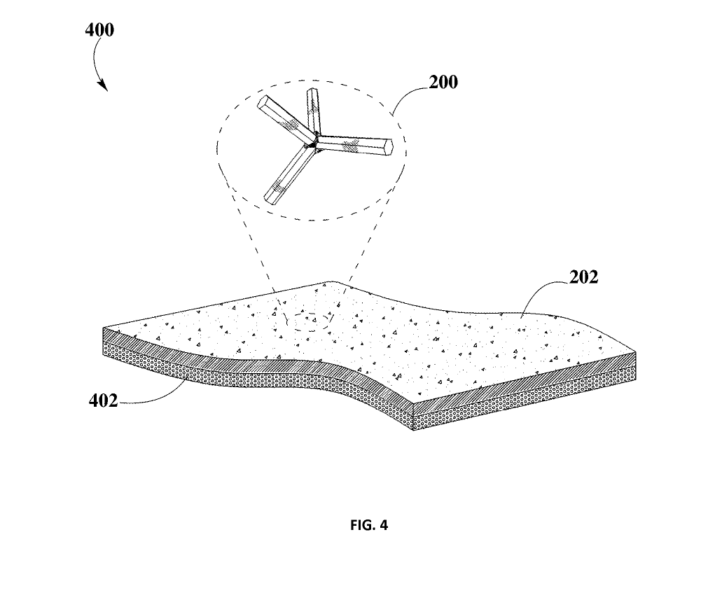

FIG. 4 shows a photoactive material B 400 including treated photocatalytic capped colloidal nanocrystals 202 in tetrapod configuration 200 over porous substrate 402. Photocatalytic capped colloidal nanocrystals 202 in the photoactive material B 400 may also exhibit tetrapod, core/shell, nanorods, nanowires, nanosprings and carbon nanotubes configuration, among others.

System Configuration and Functioning

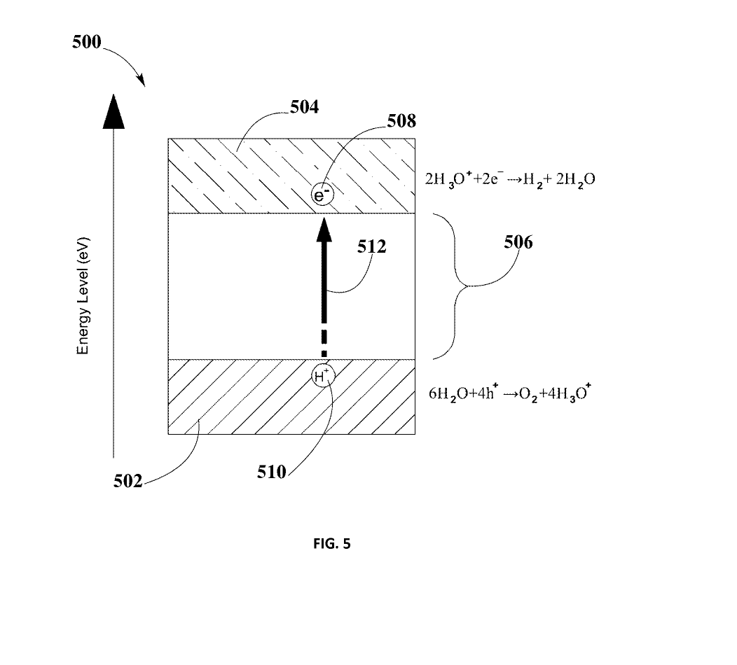

FIG. 5 shows a charge separation process A 500 that may occur during water splitting process.

The energy difference between a valence band 502 and a conduction band 504 of a semiconductor nanocrystal is known as band gap 506. Valence band 502 refers to the outermost electron 508 shell of atoms in semiconductor nanocrystals and insulators in which electrons 508 are too tightly bound to the atom to carry electric current, while conduction band 504 refers to the band of orbitals that are high in energy and are generally empty. Band gap 506 of semiconductor nanocrystals should be large enough to drive water splitting process reactions, but small enough to absorb a large fraction of light wavelengths. The manifestation of band gap 506 in optical absorption is that only photons with energy larger than or equal to band gap 506 are absorbed.

When light with energy equal to or greater than that of band gap 506 makes contact with semiconductor nanocrystals in photoactive material A 300, electrons 508 are excited from valence band 502 to conduction band 504, leaving holes 510 behind in valence band 502, a process triggered by photo-excitation 512. Changing the materials and shapes of semiconductor nanocrystals may enable the tuning of band gap 506 and band-offsets to expand the range of wavelengths usable by semiconductor nanocrystal and to tune the band positions for redox processes.

For water splitting process, the photo-excited electron 508 in semiconductor nanocrystal should have a reduction potential greater than or equal to that necessary to drive the following reaction:

2H₃O⁺+2e⁻→H₂+2H₂O (1)

The above stated reaction may have a standard reduction potential of 0.0 eV vs. Standard Hydrogen Electrode (SHE), or standard hydrogen potential of 0.0 eV. Hydrogen (H₂) molecule in water may be reduced when receiving two photo-excited electrons 508 moving from valence band 502 to conduction band 504. On the other hand, the photo-excited hole 510 should have an oxidation potential greater than or equal to that necessary to drive the following reaction:

6H₂O+4h⁺→O₂+4H₃O⁺ (2)

The above stated reaction may exhibit a standard oxidation potential of −1.23 eV vs. SHE. Oxygen (O₂) molecule in water may be oxidized by four holes 510. Therefore, the absolute minimum band gap 506 for semiconductor nanocrystal in a water splitting reaction is 1.23 eV. Given over potentials and loss of energy for transferring the charges to donor and acceptor states, the minimum energy may be closer to 2.1 eV. The wavelength of the irradiation light may be required to be about 1010 nm or less, in order to allow electrons 508 to be excited and jump over band gap 506.

Electrons 508 may acquire energy corresponding to the wavelength of the absorbed light. Upon being excited, electrons 508 may relax to the bottom of conduction band 504, which may lead to recombination with holes 510 and therefore to an inefficient water splitting process. For efficient charge separation process A 500, a reaction has to take place to quickly sequester and hold electron 508 and hole 510 for use in subsequent redox reactions used for water splitting process.

According to one embodiment, semiconductor nanocrystal in photoactive material A 300 may be capped with first inorganic capping agent 208 and second inorganic capping agent 210 as a reduction photocatalyst and an oxidative photocatalyst, respectively. Following photo-excitation 512 to conduction band 504, electron 508 can quickly move to the acceptor state of first inorganic capping agent 208 and hole 510 can move to the donor state of second inorganic capping agent 210, preventing recombination of electrons 508 and holes 510. First inorganic capping agent 208 acceptor state and second inorganic capping agent 210 donor state lie energetically between the band edge states and the redox potentials of the hydrogen and oxygen producing half-reactions. The sequestration of the charges into these states may also physically separate electrons 508 and holes 510, in addition to the physical charge carriers' separation that occurs in the boundaries between individual semiconductor nanocrystals. Being more stable to recombination in the donor and acceptor states, charge carriers may be efficiently stored for use in redox reactions required for photocatalytic water splitting process.

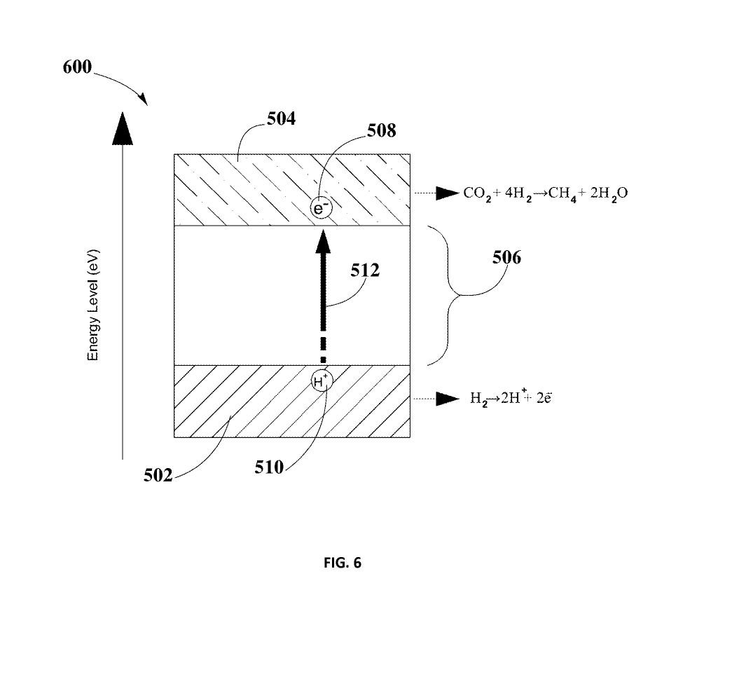

FIG. 6 illustrates a charge separation process B 600 that may occur during carbon dioxide reduction process.

Band gap 506 of semiconductor nanocrystals should be large enough to drive carbon dioxide reduction reactions but small enough to absorb a large fraction of light wavelengths. Band gap 506 of photocatalytic capped colloidal nanocrystal employed in the reduction of carbon dioxide should be at least 1.33 eV, which corresponds to absorption of solar photons of wavelengths below 930 nm. Considering the energy loss associated with entropy change (87 J/mol·K) and other losses involved in carbon dioxide reduction (forming methane and water vapor), band gap 506 between about 2 and about 2.4 eV may be preferred. The manifestation of band gap 506 in optical absorption is that only photons with energy larger than or equal to band gap 506 are absorbed.

Electrons 508 may acquire energy corresponding to the wavelength of absorbed light. Upon being excited, electrons 508 may relax to the bottom of conduction band 504, which may lead to recombination with holes 510 and, therefore, to an inefficient charge separation process B 600.

According to one embodiment, to achieve the charge separation process B 600, semiconductor nanocrystal in photoactive material B 400 may be capped with first inorganic capping agent 208 and second inorganic capping agent 210 as a reduction photocatalyst and an oxidative photocatalyst, respectively. Following photo-excitation 512 to conduction band 504, electron 508 can quickly move to the acceptor state of first inorganic capping agent 208 and hole 510 can move to the donor state of second inorganic capping agent 210, preventing recombination of electrons 508 and holes 510. First inorganic capping agent 208 acceptor state and second inorganic capping agent 210 donor state lie energetically between the limits of band gap 506 and the redox potentials of the hydrogen oxidation and carbon dioxide reduction reactions. By being more stable to recombination in the donor and acceptor states, charge carriers may be stored for use in redox reactions required for a more efficient charge separation process B 600, and hence, a more productive carbon dioxide reduction process.

When semiconductor nanocrystals in photoactive material B 400 are irradiated with photons having a level of energy greater than band gap 506 of photoactive material B 400, electrons 508 may be excited from valence band 502 into conduction band 504, leaving holes 510 behind in valence band 502. Excited electrons 508 may reduce carbon dioxide molecules into methane, while holes 510 may oxidize hydrogen gas molecules. Oxidized hydrogen molecules may react with carbon dioxide and form water and methane via a series of reactions that may be summarized by the equations on table 1:

Table 1: Carbon Dioxide Reduction Equations

| Equation | Product |
|---|---|
| O₂ + 2H⁺ + 2e⁻ → HCOOH | Formic acid |
| COOH + 2H⁺ + 2e⁻ → HCHO + H₂O | Formaldehyde |
| HCHO + 2H⁺ + 2e⁻ → CH₃OH | Methanol |
| CH₃OH + 2H⁺ + 2e⁻ → CH₄ + H₂O | Methane |

According to table 1, in the carbon dioxide reduction process, carbon dioxide, in the presence of hydrogen, may be photo-catalytically reduced into methane and water. Electrons 508 may be obtained from photoactive material B 400 and hydrogen atoms may be obtained from hydrogen gas. Beginning from adsorbed carbon dioxide, formic acid (HCOOH) may be formed by accepting two electrons 508 and adding two hydrogen atoms. Then, formaldehyde (HCHO) and water molecules may be formed from the reduction of formic acid by accepting two electrons 508 and adding two hydrogen atoms. Subsequently, methanol (CH₃OH) may be formed when formaldehyde accepts two electrons 508 and two hydrogen atoms may be added to formaldehyde. Finally, methane may be formed when methanol accepts two electrons 508 and two hydrogen atoms are added to methanol. In addition, water may be formed as a byproduct of the reaction.

The reduction of carbon dioxide to methane requires reducing the chemical state of carbon from C (4+) to C (4−). Eight electrons are required for the production of each methane. Taken as a whole, eight hydrogen atoms and eight electrons progressively transfer to one adsorbed carbon dioxide molecule resulting in the production of one methane molecule. Similarly, oxygen released from carbon dioxide may react with free hydrogen radicals and form water vapor molecules.

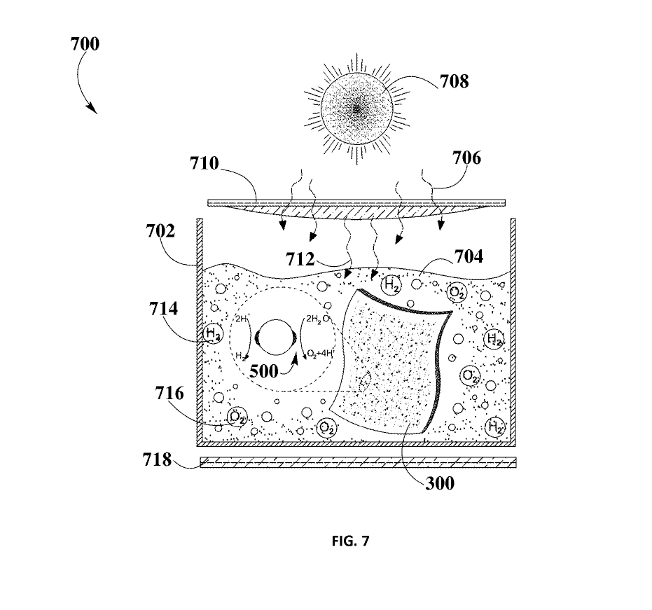

FIG. 7 shows a water splitting process 700, where a reaction vessel A 702 may contain photoactive material A 300 submerged in water 704. Light 706 coming from light source 708 may be intensified by light intensifier 710, which can be a solar concentrator, such as a parabolic solar concentrator. Light intensifier 710 may reflect light 706 and may direct intensified light 712 at reaction vessel A 702 through a window. Subsequently, intensified light 712 may come in contact with photoactive material A 300 and may produce charge separation process A 500 (explained in FIG. 5) and charge transfer (explained in FIG. 5) in the boundary between photoactive material A 300 and water 704; consequently splitting water 704 into hydrogen gas 714 and oxygen gas 716. According to an embodiment, solar reflector 718 may be positioned at the bottom or any side of reaction vessel A 702 in order to reflect intensified light back to reaction vessel A 702 and re-use intensified light 712.

According to various embodiments, one or more walls of reaction vessel A 702 may be formed of glass or other transparent material, so that intensified light may enter reaction vessel A 702. It is also possible that most or all of the walls of reaction vessel A 702 are transparent such that intensified light 712 may enter from many directions. In another embodiment, reaction vessel A 702 may have one side which is transparent to allow the incident radiation to enter and the other sides may have a reflective interior surface which reflects the majority of the solar radiation.

Any light source 708 may be employed to provide light 706 for generating water splitting process 700 to produce hydrogen gas 714 and oxygen gas 716. A preferable light source 708 is sunlight containing infrared light 706, which may be used to heat water 704 and also containing ultraviolet light 706 and visible light 706, which may be used in water splitting process 700. The ultraviolet light 706 and visible light 706 may also heat water 704, directly or indirectly. Sunlight may be diffuse light 706, direct light 706 or both. Light 706 may be filtered or unfiltered, modulated or unmodulated, attenuated or unattenuated. Preferably, light 706 may be concentrated to increase the intensity using light intensifier 710, which may include any combination of lenses, mirrors, waveguides, or other optical devices, to increase the intensity of light 706. The increase in the intensity of light 706 may be characterized by the intensity of light 706 having from about 300 to about 1500 nm (e.g., from about 300 nm to about 800 nm) in wavelength. Light intensifier may increase the intensity of light 706 by any factor, preferably by a factor greater than about 2, more preferably a factor greater than about 10, and most preferably a factor greater than about 25.

Water splitting process 700 may be characterized by the efficiency of converting light 706 energy into chemical energy. Hydrogen gas 714, when reacted with oxygen gas 716 liberates 2.96 eV per water 704 molecule. Thus, the amount of chemical energy can be determined by multiplying the number of hydrogen molecules generated by 2.96 eV. The energy of solar light 706 is defined as the amount of energy in light 706 having a wavelength from about 300 nm to about 800 nm. A typical solar intensity as measured at the Earth's surface, thus defined, is about 500 watts/m². The efficiency of water splitting process 700 can be calculated as:

Efficiency=[(2.96 eV×(1.602×10⁻¹⁹J/eV)−N/t]/(I_{L}×A_{L}) (3)

where t is the time in seconds, I_{L} is the intensity of light 706 (between 300 nm and 800 nm) in watts/m², A_{L} is the area of light 706 entering reaction vessel A 702 in m², N is the number of hydrogen molecules generated in time t, and 1 watt=1 J/s.

In one embodiment, water splitting process 700 may take place in the boundary between photoactive material A 300 and water 704, photoactive material A 300 may include photocatalytic capped colloidal nanocrystals 202 in tetrapod configuration 200. Photocatalytic capped colloidal nanocrystals 112 includes semiconductor nanocrystal capped with first inorganic capping agent 208 and second inorganic capping agent 210, acting as a reduction photocatalyst and oxidation photocatalyst respectively. When light 706 emitted by light source 708 makes contact with semiconductor nanocrystal, charge separation process A 500 and charge transfer process may take place between semiconductor nanocrystal, first inorganic capping agent 208, second inorganic capping agent 210 and water 704. As a result, hydrogen may be reduced by electrons 508 moving from valence band 502 to conduction band 504 when electrons 508 may be transferred via first inorganic capping agent 208 to water 704, producing hydrogen gas 714 molecules. On the other hand, oxygen may be oxidized by holes 510, when holes 510 are transferred via second inorganic capping agent 210 to water 704, resulting in the production of oxygen gas 716 molecules.

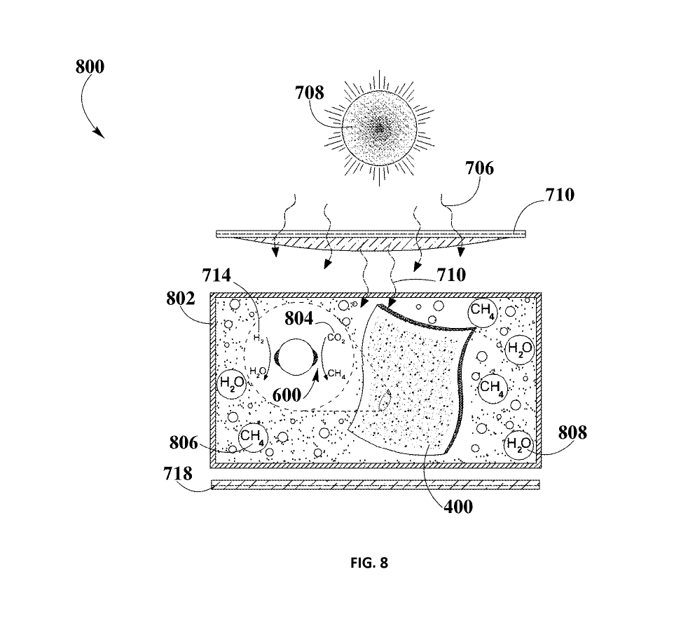

FIG. 8 represents carbon dioxide reduction process 800, where reaction vessel B 802 may contain photoactive material B 400. Carbon dioxide 804 may be introduced into reaction vessel B 802 via an inlet line. Similarly, hydrogen gas 714 may be injected into reaction vessel B 802 by another inlet line.

Light 706 coming from light source 708 may be intensified by light intensifier 710. Light intensifier 710 may reflect light 706 and may direct intensified light at reaction vessel B 802 through a window. Carbon dioxide 804 and hydrogen gas 714 may pass through photoactive material B 400 prior to entering into reaction vessel B 802. Intensified light 712 may react with photoactive material B 400 and may produce charge separation process B 600 (explained in FIG. 6) in the boundary of photoactive material B 400. Carbon dioxide 804 may be reduced and hydrogen gas 714 may be oxidized by a series of reactions until methane 806 and water vapor 808 are produced.

According to an embodiment, solar reflector 718 may be positioned at the bottom or any side of reaction vessel B 802 to reflect intensified light 712 back to reaction vessel B 802 and re-use intensified light 712.

According to various embodiments, one or more walls of reaction vessel B 802 may be formed of glass or other transparent material, so that intensified light 712 may enter reaction vessel B 802. At least one or more walls of reaction vessel B 802 may be transparent such that intensified light 712 may enter and may react with photoactive material B 400. In another embodiment, reaction vessel B 802 may have one transparent side to allow intensified light 712 to enter, while the other sides may have a reflective interior surface to reflect the majority of intensified light 712 into photoactive material B 400.

Any light source 708 may be employed to provide light 706 for carbon dioxide reduction process 800. A preferable light source 708 is sunlight, containing infrared light 706 and also containing ultraviolet light 706 and visible light 706 which may be used in carbon dioxide reduction process 800. Sunlight may be diffuse light 706, direct light 706 or both. Light 706 may be filtered or unfiltered, modulated or unmodulated, attenuated or unattenuated. Preferably, light 706 may be concentrated to increase the intensity using light intensifier 710.

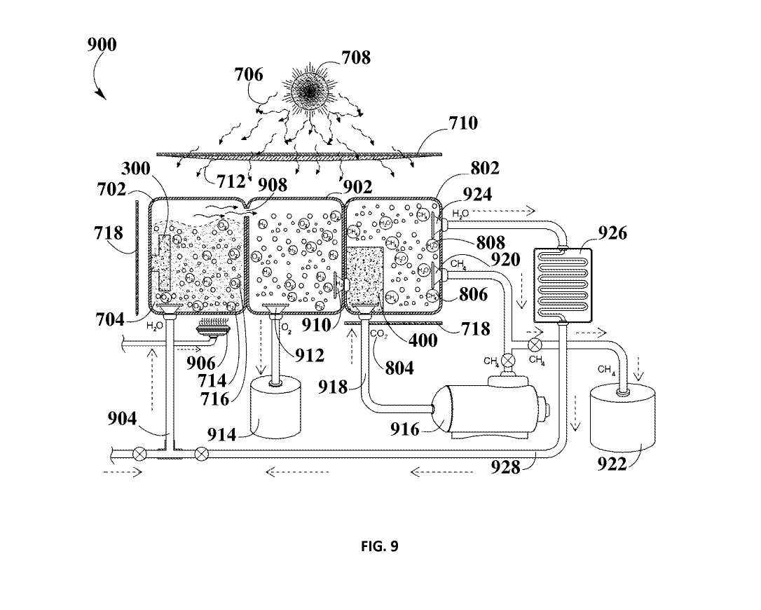

FIG. 9 represents photosynthetic system 900 employing water splitting process 700 and carbon dioxide reduction process 800. Photosynthetic system 900 may include reaction vessel A 702, gas collecting chamber 902 and reaction vessel B 802.

In photosynthetic system 900 reaction vessel A 702 contains photoactive material A 300 that may be submerged in water 704. Light 706 coming from light source 708 may be intensified by light intensifier 710. Light intensifier 710 may reflect light 706 and may direct intensified light 712 at reaction vessel A 702 through a window. Subsequently, intensified light 712 may come in contact with photoactive material A 300 and may produce charge separation process A 500 splitting water 704 into hydrogen gas 714 and oxygen gas 716. In one embodiment, solar reflector 718 may be positioned at any side of reaction vessel A 702 to reflect intensified light 712 back to reaction vessel A 702 and re-utilize intensified light 712.

A continuous flow of water 704 may enter reaction vessel A 702 through inlet line A 904 to a region containing photoactive material A 300. Preferably, heater 906 may be connected to reaction vessel A 702 in order to produce heat, so that water 704 may boil, facilitating the migration of hydrogen gas 714 and oxygen gas 716 from reaction vessel A 702 to gas collecting chamber 902 through opening 908. Heater 906 may be set to a temperature of at least 100° C. Heater 906 may be powered by different energy supplying devices. Preferably, heater 906 may be powered by renewable energy supplying devices, such as photovoltaic cells, or by energy stored employing the system and method from the present disclosure. Materials for the walls of reaction vessel A 702 may be selected based on the reaction temperature.

After reaction vessel A 702, hydrogen gas 714 and oxygen gas 716 may migrate through opening 908 to gas collecting chamber 902. Gas collecting chamber 902 may include hydrogen permeable membrane 910 (e.g. silica membrane) and oxygen permeable membrane 912 (e.g. silanized alumina membrane). Oxygen permeable membrane 912 may absorb only oxygen gas 716 and subsequently transfer oxygen gas 716 into oxygen storage tank 914 or into any other suitable storage equipment. Hydrogen permeable membrane 910 may absorb hydrogen gas 714 and subsequently transfer hydrogen gas 714 into reaction vessel B 802 through photoactive material B 400. Flow of hydrogen gas 714, oxygen gas 716 and water 704 may be controlled by one or more valves, pumps or other flow regulators.

Photosynthetic system 900 may operate in conjunction with a combustion system that produces carbon dioxide 804 as a byproduct. In an embodiment, photosynthetic system 900 may be employed to take advantage of carbon dioxide 804 produced by one or more boilers 916 during a manufacturing process. Boiler 916 may be connected to reaction vessel B 802 by inlet line B 918 that may allow a continuous flow of carbon dioxide 804 gas through photoactive material B 400 along with hydrogen gas 714 into reaction vessel B 802.

Light 706 coming from light source 708 may be intensified by light intensifier 710. Light intensifier 710 may reflect light 706 and may direct intensified light 712 at reaction vessel B 802 through a window. Carbon dioxide 804 and hydrogen gas 714 may pass through photoactive material B 400 prior to entering into reaction vessel B 802. Intensified light 712 may react with photoactive material B 400 to produce charge separation process B 600. In an embodiment, solar reflector 718 may be positioned at any side of reaction vessel B 802 to reflect intensified light 712 back to reaction vessel B 802 and re-use intensified light 712.

When carbon dioxide 804 and hydrogen gas 714 come in contact with photoactive material B 400, carbon dioxide reduction process 800 may take place through reactions summarized in table 1 (explained in FIG. 6). Optionally, a heater (not shown in FIG. 9) may be employed to increase the temperature in reaction vessel B 802.

After carbon dioxide reduction process 800, the produced methane 806 may exit reaction vessel B 802 through methane permeable membrane 920 (e.g. polyimide resin membrane) to be subsequently stored in methane storage tank 922 or any suitable storage medium or may be directly used as fuel by boiler 916, according to the manufacturing process needs of the industry that applies photosynthetic system 900.

Water vapor 808 may exit reaction vessel B 802 through water vapor permeable membrane 924 (e.g. polydimethylsiloxane membrane) and may be transferred to water condenser 926 where liquid water 704 may be obtained. Valves, pumps and/or monitoring devices may be added in order to measure and regulate pressure and/or flow rate. Flow rate of carbon dioxide 804 and hydrogen gas 714 into reaction vessel B 802 may be adjusted depending on reaction time between carbon dioxide 804, hydrogen gas 714 and photoactive material B 400 needed. Optionally, a gas sensor device (not shown in this figure) may be installed near reaction vessel B 802 to identify any methane 806 leakage.

Liquid water may be employed for different purposes in the manufacturing process. In an embodiment, liquid water may be recirculated through pipeline 928 to supply water to reaction vessel A 702. Stored methane 806 produced in photosynthetic system 900 may be burned as industrial fuel for boilers 916 and kilns, residential fuel, vehicle fuel, and/or as fuel for turbines for electricity production.

### EXAMPLES

Example #1 is an embodiment of photosynthetic system 900 where gas collecting chamber 902 is not included, in which oxygen gas 716 and hydrogen gas 714 from reaction vessel A 702 may be transferred directly into reaction vessel B 802. Hydrogen gas 714 may pass through hydrogen permeable membrane 910 in order to be transferred into reaction vessel B 802; oxygen gas 716 may pass through oxygen permeable membrane 912 in order to be collected into an oxygen storage tank 914.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

What is claimed is:

1. A photosynthetic system comprising a photoactive material comprising photocatalytic capped colloidal nanocrystals, wherein methane and water are produced by a carbon dioxide reduction process in the presence of hydrogen.

2. The system according to claim 1, wherein the photoactive material further comprises a first photoactive material for splitting water into hydrogen and oxygen.

3. The system according to claim 2, wherein the photoactive material further comprises a second photoactive material for reducing carbon dioxide into water and methane.

4. The system according to claim 1, wherein the photoactive material comprises photocatalytic capped colloidal nanocrystals and semiconductor nanocrystals.

5. The system according to claim 1, wherein the photoactive material absorbs light for producing charge carriers to accelerate redox reactions and prevent charge carriers recombination.

6. The system according to claim 1, wherein the photoactive material comprises photocatalytic capped colloidal nanocrystals disposed on a substrate.

7. The system according to claim 6, wherein the photocatalytic capped colloidal nanocrystals are in a tetrapod, core/shell, nanorod, nanowire, nanospring, or carbon nanotube configuration.

8. The photoactive material according to claim 6, wherein the substrate is porous.

9. A photosynthetic method comprising:
passing water from a first reaction vessel through a region having a first photoactive material, wherein the first photoactive material has semiconductor nanocrystals;
exposing the first photoactive material to emitted light having energy greater than that of the band gap of semiconductor nanocrystals within the first photoactive material;
migrating hydrogen and oxygen through an opening into a gas collecting chamber comprising a permeable membrane that transfers hydrogen to a second reaction vessel;
passing the hydrogen and carbon dioxide through a second photoactive material having semicondutor nanycrystals prior to entering a second reaction vessel;
injecting carbon dioxide into the second reaction vessel; and
exposing the second photoactive material to emitted light with energy higher than that of the band gap of semiconductor nanocrystals with the second photoactive material.

10. The method according to claim 9, wherein the semiconductor nanocrystals in the first photoactive material absorb light at a different wavelength than a bulk material of the first photoactive material.

11. The method according to claim 9, wherein the semiconductor nanocrystals in the first photoactive material absorb light at a shorter wavelength than a bulk material of the first photoactive material.

12. The method according to claim 9, wherein the emitted light has a minimum energy of about 2.1 eV.

13. The method according to claim 9, further comprising a second permeable membrane in the gas collecting chamber that transfers oxygen to a storage tank.

14. The method according to claim 9, wherein the second photoactive material comprises photocatalytic capped colloidal nanocrystals.

15. The method according to claim 14, wherein the photocatalytic capped colloidal nanocrystals have a band gap of at least 1.33 eV.

16. The method according to claim 15, wherein the photocatalytic capped colloidal nanocrystals have a band gap between about 2.0 eV and 2.4 eV.

17. The method according to claim 14, wherein the photocatalytic capped colloidal nanocrystals comprise at least one semiconductor nanocrystal and at least one inorganic capping agent.

18. The method according to claim 14, wherein the photocatalytic capped colloidal nanocrystals comprise a reduction inorganic capping agent and an oxidation inorganic capping agent.

19. The method according to claim 9, wherein an energy gap of the seminconductor nanocrystals within the first photoactive material is large enough to split the water into hydrogen and oxygen and small enough to absorb light wavelengths incident upon the surface of the earth.

20. The method according to claim 9, further comprising substituting an organic capping agent with an inorganic capping agent by mixing organic capped semiconductor nanocrystals with an inorganic capping agent, whereby the organic capping agent is released.

21. The method according to claim 20, wherein the inorganic capping agent is dissolved in a polar solvent.

22. The method according to claim 20, wherein the organic capped semiconductor nanocrystals are dissolved in a non-polar solvent.

23. A photosynthetic system comprising:
a first photoactive material comprising photocatalytic capped colloidal nanocrystals; and
a second photoactive material comprising photocatalytic capped colloidal nanocrystals,
wherein methane and water are produced by a carbon dioxide reduction process in the presence of hydrogen.

24. The system according to claim 23, wherein the first photoactive material splits water into hydrogen and oxygen.

25. The system according to claim 23, wherein the second photoactive material reduces carbon dioxide into water and methane.

26. The system according to claim 23, wherein the first and second photoactive materials further comprise semiconductor nanocrystals.

27. The system according to claim 23, wherein the first or second photoactive material absorbs light for producing charge carriers to accelerate redox reactions and prevent charge carriers recombination.

28. The system according to claim 23, wherein the photocatalytic capped colloidal nanocrystals are in a tetrapod, core/shell, nanorod, nanowire, nanospring, or carbon nanotube configuration.
